(19) United States
(12) Patent Application Publication
(10) Pub. No.: US 2025/0347560 A1
(43) Pub. Date: Nov. 13, 2025

(54) METHOD FOR PREDICTING DRY PAINT COLOR VALUE FROM LIQUID PAINT COLOR VALUE

(71) Applicant: KCC CORPORATION, Seoul (KR)

(72) Inventors: Jun Hyuk KIM, Seoul (KR); Seong Min HONG, Gyeonggi-do (KR); Chul Kyu KIM, Seoul (KR); Young Soo KIM, Gyeonggi-do (KR)

(21) Appl. No.: 18/861,378

(22) PCT Filed: May 2, 2023
(86) PCT No.: PCT/KR2023/005964

§ 371 Date: Oct. 29, 2024

(30) Foreign Application Priority Data
May 4, 2022 (KR) 10-2022-0055764

(51) Int. Cl. G01J 3/46; G01N 21/17; G01N 21/25

(52) U.S. Cl. CPC G01J 3/463; G01N 21/251; G01N 2021/1748; G01N 2021/1761

(57) ABSTRACT

The present invention relates to a method for predicting a dry paint color value from a liquid paint color value, and, when producing a second liquid film having the same component as a first liquid film, a process for producing a second dry film by drying and curing the second liquid film can be skipped, and a reflection rate of the second dry film can be predicted according to the prediction method according to the present invention.

### TECHNICAL FIELD

The present invention relates to a method for predicting a dry paint color value from a liquid paint color value.

### BACKGROUND ART

The preparation process of a paint typically comprises adding paint components, mixing them according to a required process, and inspecting the target color value before the final step. For example, raw materials required for the preparation of a paint are injected, mixed, dispersed and dissolved to adjust the color, and is subjected to a color inspection step to finally complete the preparation process. Here, the color inspection step comprises a dry film formation step of sampling a small amount of a liquid paint being prepared and drying same, and conventionally further comprises a spraying process of a liquid paint or a painting process using a brush, a roller, and a bar coater, followed by a drying/curing process of the paint according to curing conditions.

In the preparation process of the paint, color verification involves the steps of collecting liquid paint samples, forming a coating film, and drying/curing same, which should be performed over a period of from one hour to several hours, which may delay the preparation process, generate a waste paint due to the use of collected samples, and cause environmental problems.

Meanwhile, even if paints are prepared with the same components, the color values of the liquid paints and the dry paints prepared therefrom may vary depending on the manufacturing environment, such as the mixing, drying and curing environments. Therefore, there is a problem that, even when the same components are input to prepare a liquid paint and a dry paint prepared therefrom, the color values of the liquid paints and dry paints prepared therefrom as final products may vary.

Therefore, the dry paint color verification process comprising the spraying process or the painting process of a brush, a roller and a bar coater, followed by the drying/curing process, is needed to be replaced with the liquid paint color verification process performed in a liquid paint state. In addition, the trend of the color values of the liquid paint and dry paint prepared therefrom is needed to be standardized and derived as an algorithm, such that a dry paint color value can be predicted only with a liquid paint color value in the preparation process of a single paint.

### PRIOR ART CITATIONS

### Patent Citations

(Patent Document 1) Korean Patent No. 10-2191784 (Dec. 10, 2020)
(Patent Document 2) Korean Laid-open Patent Publication No. 10-1985-0006893 (Oct. 21, 1985)
(Non-patent Document 1) Recipe Prediction of Colorant Proportion for Target Color Reproduction, J. of the Korean Oil Chemists' Soc., Vol. 25, No. 4, December, 2008. 438-445

### SUMMARY OF INVENTION

### Technical Problem

The present invention aims to provide a method for predicting a dry paint color value from a liquid paint color value, comprising replacing a dry paint color verification step with a liquid paint color verification step in a paint preparation process to simplify the preparation process and reduce the generation of a waste paint to solve environmental problems.

### Solution to Problem

In one aspect, the present invention can provide a method for predicting a dry paint color value from a liquid paint color value, comprising the steps of (a) preparing 1^{st} to n^{th} first liquid coating films having the same components; (b) measuring liquid reflectance 1stRwet for each of the 1^{st} to n^{th} first liquid coating films at wavelength r; (c) drying and curing each of the 1^{st} to n^{th} first liquid coating films to prepare 1^{st} to n^{th} first dry coating films; (d) measuring dry reflectance ₁ₛₜR_{Dry} for each of the 1^{st} to n^{th} first dry coating films at wavelength r; (e) obtaining a weight value (Weight) and a bias value (Bias) for the first liquid coating films at wavelength r by the following equation:

$$[ \begin{matrix}{Weight}_{r} \\ {Bias}_{r}\end{matrix} ] = {( {[ \begin{matrix}{}_{1 st} {R}_{{wet}_{1}} & 1 \\ ⋮ & ⋮ \\ {}_{1 st} {R}_{{wet}_{n}} & 1\end{matrix} ]}^{T} \cdot [ \begin{matrix}{}_{1 st} {R}_{{wet}_{1}} & 1 \\ ⋮ & ⋮ \\ {}_{1 st} {R}_{{wet}_{n}} & 1\end{matrix} ] )}^{- 1} \cdot {[ \begin{matrix}{}_{1 st} {R}_{{wet}_{1}} & 1 \\ ⋮ & ⋮ \\ {}_{1 st} {R}_{{wet}_{n}} & 1\end{matrix} ]}^{T} \cdot [ \begin{matrix}{}_{1 st} {R}_{{Dry}_{1}} \\ ⋮ \\ {}_{1 st} {R}_{{Dry}_{n}}\end{matrix} ] ,$$

wherein, when

$$R = [ \begin{matrix}{}_{1 st} {R}_{{wet}_{1}} & 1 \\ ⋮ & ⋮ \\ {}_{1 st} {R}_{{wet}_{n}} & 1\end{matrix} ] ,$$

R^{T} is a transposed matrix of matrix R, and R⁻¹ is an inverse matrix of matrix R; (f) preparing a second liquid coating film having the same components as the first liquid coating films; (g) measuring liquid reflectance _{2nd}R_{wet} for the second liquid coating film at wavelength r; and (h) applying the weight value (Weight) and the bias value (Bias) in step (e) and applying the _{2nd}R_{wet} in step (g) to the following equation: _{2nd}R_{Dry}_{ᵣ}=Weightᵣ×_{2nd}R_{wet}_{ᵣ}+Biasᵣ, to obtain dry reflectance _{2nd}R_{Dry} for the second dry coating film at wavelength r.

### Advantageous Effects of Invention

The method for predicting a dry paint color value from a liquid paint color value according to the present invention can omit a dry paint color verification step and predict a dry paint color value from a liquid paint color value, thereby simplifying the preparation process and reducing the generation of a waste paint to solve environmental problems.

### MODE FOR INVENTION

Hereinafter, the present invention will be described in detail with reference to the following examples.

Korean Patent No. 10-2191784 (hereinafter referred to as “Patent Document 1”) discloses an electrodeposition coating system equipped with a liquid paint inspection kit, and also discloses a color measuring device configured to measure the color of a liquid paint through a viewing window. However, Patent Document 1 merely discloses the measurement of the color of a liquid paint, without teaching or suggesting the prediction of the color of a dry paint from the measurement.

The present invention provides a method for predicting a dry paint color value from a liquid paint color value.

According to the present invention, a first liquid coating film and a first dry coating film dried and cured therefrom are prepared. The reflectance at wavelength r is measured for the prepared first liquid coating film and first dry coating film. The measured reflectances of the first liquid coating film and first dry coating film are applied to the equation according to the present invention to obtain a weight value (Weight) and a bias value (Bias) applied to the relationship between the reflectance of the liquid coating film and the reflectance of the dry coating film.

Thereafter, a second liquid coating film having the same components as the first liquid coating film is prepared, and the weight value (Weight) and bias value (Bias) obtained by applying the reflectances of the first liquid coating film and the first dry coating film may be used to predict the reflectance of the second dry coating film.

Therefore, according to the method for predicting a dry paint color value from a liquid paint color value according to the present invention, when producing a second liquid paint coating film having the same components as the first liquid paint coating film, the process of drying and curing the second liquid paint coating film to prepare a second dry paint coating film can be omitted, and the reflectance of the second dry coating film can be predicted according to the prediction method according to the present invention.

The method for predicting a dry paint color value from a liquid paint color value according to the present invention may comprise the steps of (a) preparing 1^{st} to n^{th} first liquid coating films having the same components; (b) measuring liquid reflectance ₁ₛₜR_{wet} for each of the 1^{st} to n^{th} first liquid coating films at wavelength r; (c) drying and curing each of the 1^{st} to n^{th} first liquid coating films to prepare 1^{st} to n^{th} first dry coating films; (d) measuring dry reflectance ₁ₛₜR_{Dry} for each of the 1^{st} to n^{th} first dry coating films at wavelength r; (e) obtaining a weight value (Weight) and a bias value (Bias) for the first liquid coating films at wavelength r by the following equation:

$$[ \begin{matrix}{Weight}_{r} \\ {Bias}_{r}\end{matrix} ] = {( {[ \begin{matrix}{}_{1 st} {R}_{{wet}_{1}} & 1 \\ ⋮ & ⋮ \\ {}_{1 st} {R}_{{wet}_{n}} & 1\end{matrix} ]}^{T} \cdot [ \begin{matrix}{}_{1 st} {R}_{{wet}_{1}} & 1 \\ ⋮ & ⋮ \\ {}_{1 st} {R}_{{wet}_{n}} & 1\end{matrix} ] )}^{- 1} \cdot {[ \begin{matrix}{}_{1 st} {R}_{{wet}_{1}} & 1 \\ ⋮ & ⋮ \\ {}_{1 st} {R}_{{wet}_{n}} & 1\end{matrix} ]}^{T} \cdot [ \begin{matrix}{}_{1 st} {R}_{{Dry}_{1}} \\ ⋮ \\ {}_{1 st} {R}_{{Dry}_{n}}\end{matrix} ] ,$$

wherein, when

$$R = [ \begin{matrix}{}_{1 st} {R}_{{wet}_{1}} & 1 \\ ⋮ & ⋮ \\ {}_{1 st} {R}_{{wet}_{n}} & 1\end{matrix} ] ,$$

R^{T} is a transposed matrix of matrix R, and R⁻¹ is an inverse matrix of matrix R; (f) preparing a second liquid coating film having the same components as the first liquid coating films; (g) measuring liquid reflectance _{2nd}R_{wet} for the second liquid coating film at wavelength r; and (h) applying the weight value (Weight) and the bias value (Bias) in step (e) and applying the _{2nd}R_{wet} in step (g) to the following equation: _{2nd}R_{Dry}_{ᵣ}=Weightᵣ×_{2nd}R_{wet}_{ᵣ}+Biasᵣ, to obtain dry reflectance _{2nd}R_{Dry} for the second dry coating film at wavelength r.

In the present invention, the relationship between the liquid coating film and dry coating film dried and cured therefrom at wavelength r (nm) may be expressed by the following equation 1:

$${R}_{{Dry}_{r}} = {Weight}_{r} \times {R}_{{Wet}_{r}} + {Bias}_{r} , \qquad [ Equation 1 ]$$

wherein
R_{Dry}_{ᵣ} is the reflectance (%) of a dry film at wavelength r (nm),
R_{Wet}_{ᵣ} is the reflectance (%) of a liquid film at wavelength r (nm),
Weightᵣ is the weight value, and
Biasᵣ is the bias value.

Therefore, liquid coating films having the same components may be prepared n times, and each of these liquid coating films may be dried and cured to prepare dry coating films, and the relationship between the liquid coating films and dry coating films may be expressed by the following equation 2:

$${R}_{{Dry}_{n , r}} = {Weight}_{r} \times {R}_{{Wet}_{n , r}} + {Bias}_{r} , \qquad [ Equation 2 ]$$

wherein
R_{Dry}_{_{n,x}} is the reflectance (%) of the nth prepared dry coating film at wavelength r (nm),
R_{wet}_{_{n,r}} is the reflectance (%) of the nth prepared liquid coating film at wavelength r (nm),
Weightᵣ is the weight value, and
Biasᵣ is the bias value.

Equation 2 may be expressed as a determinant for each of the 1^{st} to n^{th} liquid coating films and dry coating films prepared by using the same components, as the following equation 3:

$$[ \begin{matrix}{R}_{{wet}_{1 , r}} \\ ⋮ \\ {R}_{{wet}_{n , r}}\end{matrix} ] = [ \begin{matrix}{R}_{{wet}_{1 , r}} & 1 \\ ⋮ & ⋮ \\ {R}_{{wet}_{n , r}} & 1\end{matrix} ] [ \begin{matrix}{Weight}_{r} \\ {Bias}_{r}\end{matrix} ] , \qquad [ Equation 3 ]$$

wherein
R_{Dry}_{_{i,r}} is the reflectance (%) of the 1st prepared dry coating film at wavelength r (nm),
R_{Dry}_{_{n,r}} is the reflectance (%) of the nth prepared dry coating film at wavelength r (nm),
R_{wet}_{_{i,r}} is the reflectance (%) of the 1st prepared liquid coating film at wavelength r (nm),
R_{wet}_{_{n,r}} is the reflectance (%) of the nth prepared liquid coating film at wavelength r (nm),
Weightᵣ is the weight value, and
Biasᵣ is the bias value.

By applying the least square method to Equation 3, Weightᵣ and Biasᵣ at wavelength r (nm) may be obtained from the following equation 4:

$$[ \begin{matrix}{Weight}_{r} \\ {Bias}_{r}\end{matrix} ] = {( {[ \begin{matrix}{R}_{{wet}_{1}} & 1 \\ ⋮ & ⋮ \\ {R}_{{wet}_{n}} & 1\end{matrix} ]}^{T} \cdot [ \begin{matrix}{R}_{{wet}_{1}} & 1 \\ ⋮ & ⋮ \\ {R}_{{wet}_{n}} & 1\end{matrix} ] )}^{- 1} \cdot {[ \begin{matrix}{R}_{{wet}_{1}} & 1 \\ ⋮ & ⋮ \\ {R}_{{wet}_{n}} & 1\end{matrix} ]}^{T} \cdot [ \begin{matrix}{R}_{{Dry}_{1}} \\ ⋮ \\ {R}_{{Dry}_{n}}\end{matrix} ] , \qquad [ Equation 4 ]$$

$$wherein$$

$$when R = [ \begin{matrix}{R}_{{wet}_{1}} & 1 \\ ⋮ & ⋮ \\ {R}_{{wet}_{n}} & 1\end{matrix} ] ,$$

RT is the transposed matrix of matrix R, and
R−1 is the inverse matrix of matrix R.

Accordingly, the reflectance may be measured at wavelength r (nm) for each of the 1st to nth first liquid coating films prepared by using the same components and the first dry coating films prepared therefrom, and the measured reflectance may be applied to Equation 4 to obtain a weight value (Weight) and a bias value (Bias) at wavelength r (nm).

Thereafter, second liquid coating film having the same components as the first liquid coating films may be prepared, the reflectance at wavelength r (nm) of the second liquid coating film may be measured, and the measured reflectance may be applied to Equation 2 to obtain the reflectance of the second dry coating film.

Meanwhile, the color values CIE L*, a* and b* of the second dry coating film may be obtained from the reflectance of the second dry coating film obtained from Equation 2.

A method for obtaining color values CIE L*, a* and b* from reflectance is known in the art, and is disclosed, for example, in “Recipe Prediction of Colorant Proportion for Target Color Reproduction, J. of the Korean Oil Chemists' Soc., Vol. 25, No. 4, December, 2008. 438-445” (Non-patent Document 1).

For example, in the XYZ colorimetric system, the tristimulus value XYZ of the color of an object due to reflection may be obtained, for example, at a wavelength of from 380 nm to 780 nm, by using the following equations:

$$\begin{matrix}X = K {\int }_{380}^{780} S ( λ ) \overline{x} ( λ ) R ( λ ) d λ \\ Y = K {\int }_{380}^{780} S ( λ ) \overline{y} ( λ ) R ( λ ) d λ \\ Z = K {\int }_{380}^{780} S ( λ ) \overline{z} ( λ ) R ( λ ) d λ \\ K = \frac{100}{{\int }_{380}^{780} S ( λ ) \overline{y} ( λ ) R ( λ ) d λ}\end{matrix} ,$$

wherein
S(λ) is the spectral distribution of the standard illuminant used to represent color, x̅(λ), y̅(λ), z̅(λ) are the color matching functions in the XYZ colorimetric system, and R(λ) is the spectral incidence angle reflectance.

Meanwhile, the CIE L*, a* and b* colorimetric systems may be obtained by using the tristimulus value XYZ, for example, as follows:

$$\begin{matrix}{L}^{*} = 116 {( Y // {Y}_{n} )}^{1 / 2} - 16 \\ {a}^{*} = 500 [ {( X / {X}_{n} )}^{1 / 3} - {( Y / {Y}_{n} )}^{1 / 3} ] Y / {Y}_{n} > 0.008856 \\ {b}^{*} = 200 [ {( Y / {Y}_{n} )}^{1 / 3} - {( Z / {Z}_{n} )}^{1 / 3} ] \\ {L}^{*} = 903.29 ( Y / {Y}_{n} ) \\ {a}^{*} = 500 \times 7.787 [ X / {X}_{n} ) - ( Y / {Y}_{n} ) ] Y / {Y}_{n} ≦ 0.008856 \\ {b}^{*} = 200 \times 7.787 [ ( X / {Y}_{n} ) - ( Z / {Z}_{n} ) ]\end{matrix} ,$$

wherein
Xn, Yn and Zn are the tristimulus values of standard light.

Hereinafter, examples of the present invention will be described.

### EXAMPLES

### Example 1: Product Name FU2300-LGREY

For the product name FU2300-LGREY, 1^{st} to 10^{th} first liquid coating films were prepared. Specifically, 1^{st} to 10^{th} first liquid paints were prepared by using the same components applied to the preparation of the product name FU2300-LGREY Each of the prepared 1^{st} to 10^{th} first liquid paints was applied to a covering paper at a thickness of 25 μm to prepare 1^{st} to 10^{th} first liquid coating films. For each of the prepared first liquid coating films, colorimetry was performed by using a non-contact colorimeter X RITE VS450 or VS3200 at 10 nm intervals at a wavelength of 400 nm to 700 nm within 1 minute, and the reflectance was measured at 10 nm intervals at a wavelength of 400 nm to 700 nm for each of the first liquid coating films.

Meanwhile, a thinner (TH0254(N)) was added to each of the prepared 1^{st} to 10^{th} first liquid paints to adjust the viscosity according to a coating viscosity (coating viscosity: 25° C., Ford Cup No. 4, 26 to 28 seconds). Thereafter, each of the first liquid paints was applied to an electrodeposited CR steel plate with 90×200 mm by using an air sprayer 2 to 3 times in a reciprocating motion with a thickness of 35±3 μm, left at room temperature (10 to 30° C.) for 5 to 10 minutes, followed by curing at 150° C. for 30 minutes. Thereafter, the reflectance was measured by using a colorimeter X RITE 17 or C17800 at 10 nm intervals at a wavelength of 400 nm to 700 nm for each of the first dry coating films.

From the measured reflectance of the first liquid paints and first dry paints, weight values (Weight) and bias values (Bias) were obtained at 10 nm intervals in a wavelength range of 400 nm to 700 nm.

### Examples 2 to 5

The process of Example 1 was performed for each of the product names FU2300-WHITE PEARL BASE(D) (Example 2), FU2300-DGREY (Example 3), FU2300-Shimmering Silver (Example 4), and FU2300-Nocturne Gray (Example 5), to obtain the weight values (Weight) and bias values (Bias) at each wavelength.

The weight values (Weight) and bias values (Bias) at each wavelength are shown in Tables 1 to 3 below:

TABLE 1

| Product | Model | | | | | | | | | | |
|---|---|---|---|---|---|---|---|---|---|---|---|
| name | coefficient | 400 | 410 | 420 | 430 | 440 | 450 | 460 | 470 | 480 | 490 |
| FU2300- | Bias | 3.504 | 1.522 | 0.571 | −0.541 | 0.743 | 0.475 | 0.221 | 0.025 | 0.014 | −0.184 |
| LGREY | Weight | −0.114 | −0.064 | −0.061 | −0.045 | −0.074 | −0.070 | −0.073 | −0.076 | −0.079 | −0.085 |
| FU2300- | Bias | 5.103 | −1.179 | −3.455 | −3.232 | −3.385 | −4.127 | −5.158 | −6.122 | −0.136 | −8.511 |
| WHITE | Weight | −0.206 | −0.067 | −0.044 | −0.051 | −0.051 | −0.042 | −0.033 | −0.023 | −0.114 | −0.006 |
| PEARL | | | | | | | | | | | |
| BASE(D) | | | | | | | | | | | |
| FU2300- | Bias | 4.731 | 4.654 | 4.528 | 4.610 | 4.639 | 4.572 | 4.535 | 4.514 | 4.521 | 4.447 |
| DGREY | Weight | −0.133 | −0.141 | −0.145 | −0.174 | −0.191 | −0.192 | −0.202 | −0.209 | −0.220 | −0.219 |
| FU2300- | Bias | 4.279 | 4.276 | 4.057 | 4.081 | 4.110 | 4.085 | 4.034 | 4.048 | 4.078 | 4.085 |
| Shimmering | Weight | −0.040 | −0.055 | −0.059 | −0.076 | −0.090 | −0.097 | −0.108 | −0.119 | −0.131 | −0.147 |
| Silver | | | | | | | | | | | |
| FU2300- | Bias | 4.531 | 4.442 | 4.459 | 4.432 | 4.343 | 4.412 | 4.418 | 4.483 | 4.506 | 4.486 |
| Nocturne | Weight | 0.009 | 0.003 | −0.038 | −0.050 | −0.030 | −0.076 | −0.098 | −0.139 | −0.163 | −0.178 |
| Gray | | | | | | | | | | | |

TABLE 2

| Product | Model | | | | | | | | | | |
|---|---|---|---|---|---|---|---|---|---|---|---|
| name | coefficient | 500 | 510 | 520 | 530 | 540 | 550 | 560 | 570 | 580 | 590 |
| FU2300- | Bias | −0.385 | −0.387 | −0.580 | −0.524 | −0.562 | −0.426 | −0.627 | −0.639 | −0.725 | −1.080 |
| LGREY | Weight | −0.090 | −0.092 | −0.087 | −0.089 | −0.089 | −0.093 | −0.090 | −0.090 | −0.093 | −0.087 |
| FU2300- | Bias | −8.489 | −8.945 | −9.418 | −10.254 | −10.477 | −10.455 | −11.220 | −10.949 | −10.707 | −10.110 |
| WHITE | Weight | −0.016 | −0.007 | −0.002 | 0.009 | 0.012 | 0.010 | 0.019 | 0.015 | 0.009 | −0.001 |
| PEARL | | | | | | | | | | | |
| BASE (D) | | | | | | | | | | | |
| FU2300- | Bias | 4.479 | 4.478 | 4.504 | 4.486 | 4.477 | 4.497 | 4.491 | 4.480 | 4.512 | 4.449 |
| DGREY | Weight | −0.237 | −0.244 | −0.253 | −0.253 | −0.255 | −0.265 | −0.270 | −0.271 | −0.281 | −0.271 |
| FU2300- | Bias | 4.194 | 4.146 | 4.091 | 4.141 | 4.007 | 4.105 | 4.147 | 4.036 | 3.981 | 3.759 |
| Shimmering | Weight | −0.166 | −0.170 | −0.170 | −0.179 | −0.172 | −0.183 | −0.192 | −0.184 | −0.181 | −0.167 |
| Silver | | | | | | | | | | | |
| FU2300- | Bias | 4.455 | 4.522 | 4.498 | 4.462 | 4.485 | 4.469 | 4.437 | 4.432 | 4.419 | 4.448 |
| Nocturne | Weight | −0.176 | −0.218 | −0.213 | −0.205 | −0.221 | −0.231 | −0.212 | −0.214 | −0.219 | −0.233 |
| Gray | | | | | | | | | | | |

TABLE 3

| Product | Model | | | | | | | | | | | |
|---|---|---|---|---|---|---|---|---|---|---|---|---|
| name | coefficient | 600 | 610 | 620 | 630 | 640 | 650 | 660 | 670 | 680 | 690 | 700 |
| FU2300- | Bias | −1.346 | −1.337 | −1.217 | −1.300 | −1.389 | −0.239 | −0.489 | −1.144 | −1.115 | −1.447 | −1.461 |
| LGREY | Weight | −0.083 | −0.085 | −0.088 | −0.087 | −0.087 | −0.113 | −0.104 | −0.087 | −0.092 | −0.092 | −0.099 |
| FU2300- | Bias | 10.281 | 10.098 | −9.500 | −9.590 | −9.608 | −9.730 | −9.132 | −8.648 | −8.340 | −8.485 | −8.566 |
| WHITE | Weight | 0.002 | −0.001 | −0.009 | −0.009 | −0.011 | −0.010 | −0.019 | −0.021 | −0.027 | −0.030 | −0.035 |
| PEARL | | | | | | | | | | | | |
| BASE(D) | | | | | | | | | | | | |
| FU2300- | Bias | 4.421 | 4.495 | 4.471 | 4.452 | 4.418 | 4.420 | 4.394 | 4.421 | 4.392 | 4.358 | 4.376 |
| DGREY | Weight | −0.267 | −0.284 | −0.283 | −0.282 | −0.278 | −0.279 | −0.283 | −0.289 | −0.289 | −0.290 | −0.310 |
| FU2300- | Bias | 3.714 | 3.775 | 3.736 | 3.746 | 3.677 | 3.652 | 3.727 | 3.708 | 3.683 | 3.638 | 3.677 |
| Shimmering | Weight | −0.163 | −0.169 | −0.168 | −0.170 | −0.166 | −0.166 | −0.175 | −0.177 | −0.180 | −0.181 | −0.191 |
| Silver | | | | | | | | | | | | |
| FU2300- | Bias | 4.433 | 4.406 | 4.392 | 4.372 | 4.428 | 4.360 | 4.326 | 4.318 | 4.228 | 4.194 | 4.290 |
| Nocturne | Weight | −0.233 | −0.217 | −0.220 | −0.220 | −0.255 | −0.231 | −0.212 | −0.204 | −0.168 | −0.152 | −0.203 |
| Gray | | | | | | | | | | | | |

### Test Example: Comparison of Errors in Prepared Coating Films

The predicted and measured values of L*, a* and b* of Examples 1 to 5 are compared, and the error values are shown in Table 4 below:

TABLE 4

| | | | | | Error | | | |
|---|---|---|---|---|---|---|---|---|
| Product name | Category | L* | a* | b* | ΔE* | ΔL* | Δa* | Δb* |
| FU2300-LGREY | Predicted | 73.12 | −1.99 | −4.57 | 0.31 | 0 | 0.12 | −0.29 |
| | value | | | | | | | |
| | Measured | 73.12 | −2.11 | −4.28 | | | | |
| | value | | | | | | | |
| FU2300-WHITE | Predicted | 84.54 | −1.77 | 2.86 | 0.39 | 0.22 | −0.25 | −0.2 |
| PEARL BASE(D) | value | | | | | | | |
| | Measured | 84.32 | −1.52 | 3.06 | | | | |
| | value | | | | | | | |
| FU2300-DGREY | Predicted | 34.31 | −0.12 | −3.29 | 0.21 | 0.16 | −0.11 | −0.09 |
| | value | | | | | | | |
| | Measured | 34.15 | −0.01 | −3.2 | | | | |
| | value | | | | | | | |
| FU2300-Shimmering | Predicted | 44.33 | −0.75 | −1.12 | 0.26 | 0.1 | 0.06 | −0.23 |
| Silver | value | | | | | | | |
| | Measured | 44.23 | −0.81 | −0.89 | | | | |
| | value | | | | | | | |
| FU2300-Nocturne | Predicted | 30.18 | 0.44 | −2.21 | 0.08 | 0.04 | −0.06 | −0.03 |
| Gray | value | | | | | | | |
| | Measured | 30.14 | 0.5 | −2.18 | | | | |
| | value | | | | | | | |

As shown in Table 4, according to the method for predicting a dry paint color value from a liquid paint color value according to the present invention, the range of the color difference between the predicted values and the measured values of CIE L*, a* and b* of the second dry coating films may be 0.5 or less, or 0.4 or less. That is, the color difference (ΔE*) between the predicted values of CIE L*, a* and b* of the second dry coating films obtained from the dry reflectance _{2nd}R_{Dry} and the measured values of CIE L*, a* and b* of the second dry coating films prepared by drying and curing may be 0.5 or less, or 0.4 or less.

Hereinafter, various embodiments of the present invention will be described in detail.

(1) A method for predicting a dry paint color value from a liquid paint color value, comprising the steps of: (a) preparing 1^{st} to n^{th} first liquid coating films having the same components; (b) measuring liquid reflectance ₁ₛₜR_{wet} for each of the 1^{st} to n^{th} first liquid coating films at wavelength r; (c) drying and curing each of the 1^{st} to n^{th} first liquid coating films to prepare 1^{st} to n^{th} first dry coating films; (d) measuring dry reflectance ₁ₛₜR_{Dry} for each of the 1^{st} to n^{th} first dry coating films at wavelength r; (e) obtaining a weight value (Weight) and a bias value (Bias) for the first liquid coating films at wavelength r by the following equation:

$$[ \begin{matrix}{Weight}_{r} \\ {Bias}_{r}\end{matrix} ] = {( {[ \begin{matrix}{}_{1 st} {R}_{{wet}_{1}} & 1 \\ ⋮ & ⋮ \\ {}_{1 st} {R}_{{wet}_{n}} & 1\end{matrix} ]}^{T} \cdot [ \begin{matrix}{}_{1 st} {R}_{{wet}_{1}} & 1 \\ ⋮ & ⋮ \\ {}_{1 st} {R}_{{wet}_{n}} & 1\end{matrix} ] )}^{- 1} \cdot {[ \begin{matrix}{}_{1 st} {R}_{{wet}_{1}} & 1 \\ ⋮ & ⋮ \\ {}_{1 st} {R}_{{wet}_{n}} & 1\end{matrix} ]}^{T} \cdot [ \begin{matrix}{}_{1 st} {R}_{{Dry}_{1}} \\ ⋮ \\ {}_{1 st} {R}_{{Dry}_{n}}\end{matrix} ] ,$$

wherein, when

$$R = [ \begin{matrix}{}_{1 st} {R}_{{wet}_{1}} & 1 \\ ⋮ & ⋮ \\ {}_{1 st} {R}_{{wet}_{n}} & 1\end{matrix} ] ,$$

R^{T} is a transposed matrix of matrix R, and R⁻¹ is an inverse matrix of matrix R; (f) preparing a second liquid coating film having the same components as the first liquid coating films; (g) measuring liquid reflectance _{2nd}R_{wet} for the second liquid coating film at wavelength r; and (h) applying the weight value (Weight) and the bias value (Bias) in step (e) and applying the _{2nd}R_{wet} in step (g) to the following equation: _{2nd}R_{Dry}_{ᵣ}=Weightᵣ×_{2nd}R_{wet}_{ᵣ}+Biasᵣ, to obtain dry reflectance _{2nd}R_{Dry} for the second dry coating film at wavelength r.

(2) The method for predicting a dry paint color value from a liquid paint color value, wherein step (a) comprises: preparing each of 1^{st} to n^{th} first liquid paints with the same components, wherein n is an integer of 2 or more; and applying the 1^{st} to n^{th} first liquid paints to an object to be coated to prepare each of the 1^{st} to n^{th} first liquid coating films.

(3) The method for predicting a dry paint color value from a liquid paint color value, wherein step (f) comprises: preparing a second liquid paint having the same components as the first liquid paints; and applying the second liquid paint to an object to be coated to prepare the second liquid coating film.

(4) The method for predicting a dry paint color value from a liquid paint color value, wherein the method further comprises (i) obtaining predicted values of CIE L*, a* and b* of the second dry coating film from the dry reflectance _{2nd}R_{Dry} of step (h).

(5) The method for predicting a dry paint color value from a liquid paint color value, wherein a color difference (ΔE*) between the predicted values of CIE L*, a* and b* of the second dry coating film obtained from the dry reflectance _{2nd}R_{Dry} and the measured values of CIE L*, a* and b* of the second dry coating film is 0.5 or less.

1. A method for predicting a dry paint color value from a liquid paint color value, comprising the steps of:
(a) preparing 1^{st} to n^{th} first liquid coating films having the same components;
(b) measuring liquid reflectance ₁ₛₜR_{wet} for each of the 1^{st} to n^{th} first liquid coating films at wavelength r;
(c) drying and curing each of the 1^{st} to n^{th} first liquid coating films to prepare 1^{st} to n^{th} first dry coating films;
(d) measuring dry reflectance ₁ₛₜR_{Dry} for each of the 1^{st} to n^{th} first dry coating films at wavelength r;
(e) obtaining a weight value (Weight) and a bias value (Bias) for the first liquid coating films at wavelength r by the following equation:
$$[ \begin{matrix}{Weight}_{r} \\ {Bias}_{r}\end{matrix} ] = {( {[ \begin{matrix}{}_{1 st} {R}_{{wet}_{1}} & 1 \\ ⋮ & ⋮ \\ {}_{1 st} {R}_{{wet}_{n}} & 1\end{matrix} ]}^{T} \cdot [ \begin{matrix}{}_{1 st} {R}_{{wet}_{1}} & 1 \\ ⋮ & ⋮ \\ {}_{1 st} {R}_{{wet}_{n}} & 1\end{matrix} ] )}^{- 1} \cdot {[ \begin{matrix}{}_{1 st} {R}_{{wet}_{1}} & 1 \\ ⋮ & ⋮ \\ {}_{1 st} {R}_{{wet}_{n}} & 1\end{matrix} ]}^{T} \cdot [ \begin{matrix}{}_{1 st} {R}_{{Dry}_{1}} \\ ⋮ \\ {}_{1 st} {R}_{{Dry}_{n}}\end{matrix} ] ,$$
wherein, when
$$R = [ \begin{matrix}{}_{1 st} {R}_{{wet}_{1}} & 1 \\ ⋮ & ⋮ \\ {}_{1 st} {R}_{{wet}_{n}} & 1\end{matrix} ] ,$$
R^{T} is a transposed matrix of matrix R, and
R⁻¹ is an inverse matrix of matrix R;
(f) preparing a second liquid coating film having the same components as the first liquid coating films;
(g) measuring liquid reflectance _{2nd}R_{wet} for the second liquid coating film at wavelength r; and
(h) applying the weight value (Weight) and the bias value (Bias) in step (e) and applying the _{2nd}R_{wet} in step (g) to the following equation:
$${}_{2 nd} {R}_{{Dry}_{r}} = {Weight}_{r} \times {}_{2 nd} {R}_{{wet}_{1}} + {Bias}_{r} ,$$
to obtain dry reflectance _{2nd}R_{Dry} for the second dry coating film at wavelength r.

2. The method for predicting a dry paint color value from a liquid paint color value according to claim 1, wherein step (a) comprises
preparing each of 1^{st} to n^{th} first liquid paints with the same components, wherein n is an integer of 2 or more; and
applying the 1^{st} to n^{th} first liquid paints to an object to be coated to prepare each of the 1^{st} to n^{th} first liquid coating films.

3. The method for predicting a dry paint color value from a liquid paint color value according to claim 2, wherein step (f) comprises
preparing a second liquid paint having the same components as the first liquid paints; and
applying the second liquid paint to an object to be coated to prepare the second liquid coating film.

4. The method for predicting a dry paint color value from a liquid paint color value according to claim 1, wherein the method further comprises (i) obtaining predicted values of CIE L*, a* and b* of the second dry coating film from the dry reflectance _{2nd}R_{Dry} of step (h).

5. The method for predicting a dry paint color value from a liquid paint color value according to claim 4, wherein a color difference (ΔE*) between the predicted values of CIE L*, a* and b* of the second dry coating film obtained from the dry reflectance _{2nd}R_{Dry} and the measured values of CIE L*, a* and b* of the second dry coating film is 0.5 or less.
